(19) United States
(12) Patent Application Publication
(10) Pub. No.: US 2003/0001540 A1
(43) Pub. Date: Jan. 2, 2003

(54) Battery assembly having integrated rechargeable battery and battery charger

(76) Inventors: Elio Ferreira, Danbury, CT (US); Khiem Dinh Pham, Danbury, CT (US); Christine A. Frysz, New Milford, CT (US)

Correspondence Address: ROBIN BLECKER & DALEY, 2ND FLOOR, 330 MADISON AVENUE, NEW YORK, NY, 10017, US

(21) Appl. No.: 09/897,640

(22) Filed: Jun. 29, 2001

(51) Int. Cl. H02J 7/00

(52) U.S. Cl. 320/112

(57) ABSTRACT

A battery assembly having a rechargeable battery and a separate battery charging unit formed from a battery charger which is affixed to a cover, the latter cover being locked to the rechargeable battery by a locking assembly. The rechargeable battery has an outer surface and positive and negative terminals extending from the outer surface and the cover is designed to cover a portion of the outer surface of the battery exclusive of the positive and negative terminals. The latter terminals are thus not obstructed by the charger and cover and are, accordingly, accessible for external connection to the battery by the user. Additionally, the locking assembly is unlockable once locked. The cover and charger are thus permanently affixed to the rechargeable battery. Terminal pieces are used in the battery assembly which are themselves secured to the battery assembly by securing members which maintain the terminal pieces secured to the battery when the pieces are disengaged from the positive and negative terminals. Each terminal piece comprises a wing nut formed of molded plastic with a circumferential groove and each securing member has an end with an aperture for receiving the corresponding wing nut and for engaging the groove of the wing nut to rotatably hold the wing nut. The other end of each securing member is adapted to be secured to the battery assembly via the locking assembly.

### BACKGROUND OF THE INVENTION

This invention relates to battery assemblies and, in particular, to battery assemblies having a rechargeable battery and a battery charger.

Battery assemblies in which a rechargeable battery is incorporated with a battery charger are known in the art. U.S. Pat. No. 5,510,694 discloses one battery assembly of this type in which a charging unit is used in conjunction with a rechargeable battery. In this battery assembly, the charging unit is seated on and covers the entire top surface of the battery including the positive and negative battery terminals. Accordingly, the charging unit itself must be provided with positive and negative terminals for withdrawing energy from the battery assembly. The need for terminals on the charging unit requires additional hardware and connections, all of which increases the cost and complexity of the battery assembly.

Also, in the configuration in which the battery charger and battery are designed as separate units, the charger is connected to the battery using a snap lock connection. In particular, mating mechanical connectors are provided on the sides of the battery and charger. These mating connectors are releasable, thereby permitting the charger and battery to be disconnected after they have been connected.

The ability to disconnect the charger from the battery permits the charger to be easily separated from the battery and increases the likelihood that the charger may be misplaced. In such circumstances, an unsophisticated user may attempt to use a different charger to charge the battery. Since different battery chemistries, e.g. lead acid and nickel zinc, require different charging characteristics, the use of a different charger could seriously damage the battery.

It is therefore an object of the present invention to provide a battery assembly comprised of a rechargeable battery and a separate battery charging unit which overcomes the above disadvantages.

It is also an object of the present invention to provide a battery assembly comprised of a rechargeable battery and a separate battery charging unit in which the battery terminals of the battery are those accessible for external connection to the battery assembly.

It is a further object of the present invention to provide a battery assembly comprised of a rechargeable battery and a separate battery charging unit in which connection of the battery and charger is such as to prevent separation of the battery and charger once connected.

It is yet a further object of the present invention to provide a battery assembly comprised of a rechargeable battery and a separate battery charging unit in which the the terminal pieces used with the battery assembly are designed to facilitate ease of use of the battery assembly by the user.

### SUMMARY OF THE INVENTION

In accordance with the principles of the present invention, the above and other objectives are realized in a battery assembly comprised of a rechargeable battery and a separate battery charging unit in which the battery charging unit includes a battery charger which is affixed to a cover, the latter being locked to the rechargeable battery by a locking assembly. The rechargeable battery has an outer surface and positive and negative terminals extending from the outer surface and the cover is designed to cover a portion of the outer surface of the battery exclusive of the positive and negative terminals. The latter terminals are thus not obstructed by the charging unit and are, accordingly, accessible for external connection to the battery assembly.

In a further aspect of the invention, the locking assembly is configured to be unlockable once locked. The charging unit is thus permanently affixed to the rechargeable battery, thereby reducing the risk of charging the battery with a charger not suitably adapted to the battery chemistry.

In yet another aspect of the invention, the terminal pieces which are used to hold external leads to the positive and negative terminals of the rechargeable battery are themselves secured to the battery assembly by securing members which maintain the terminal pieces secured to the battery when the pieces are disengaged from the positive and negative terminals. This prevents loss of the terminal pieces and facilitates use of the battery assembly.

More particularly, each terminal piece is provided with a circumferential groove and each securing member comprises a strap having an end with an aperture for receiving the corresponding terminal piece and for engaging with the groove in the piece to rotatably hold the piece. The other end of the strap is adapted to be secured to the battery assembly. This is accomplished by use of the locking assembly.

In an additional aspect of the invention, each terminal piece comprises a wing nut with a circumferential groove. Each wing nut is also color coded so as to differentiate the wing nut for the positive terminal from the wing nut for the negative terminal.

### BRIEF DESCRIPTION OF THE DRAWINGS

The above and other features and aspects of the present invention will become more apparent upon reading the following detailed description in conjunction with the accompanying drawings, in which:

FIG. 1 shows an isometric view of a battery assembly in accordance with the principles of the present invention;

FIGS. 2-5 show front, back, top and side views, respectively, of the battery assembly of the present invention;

FIGS. 6-7 show cross-sectional views of the battery assembly of the invention taken along lines 6-6 and 7-7 of the top view of FIG. 4;

FIG. 8 shows the locking member of the locking assembly of the battery assembly of the invention

FIGS. 9-10 show views of different wing nut terminal pieces usable with the battery assembly of the invention; and

FIG. 11 shows a view of the securing strap of the securing member of the battery assembly of the invention

### DETAILED DESCRIPTION OF THE INVENTION

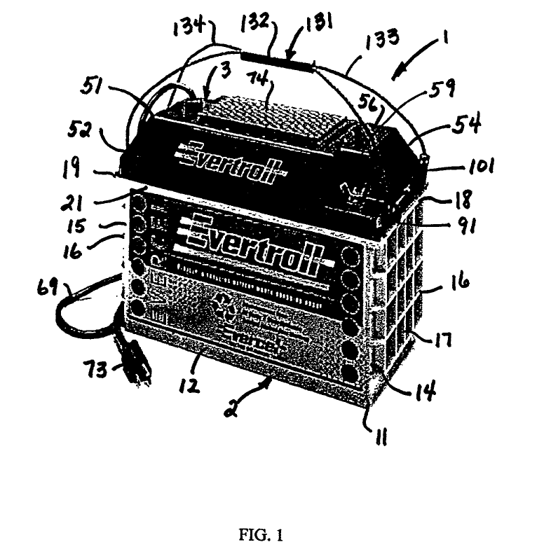

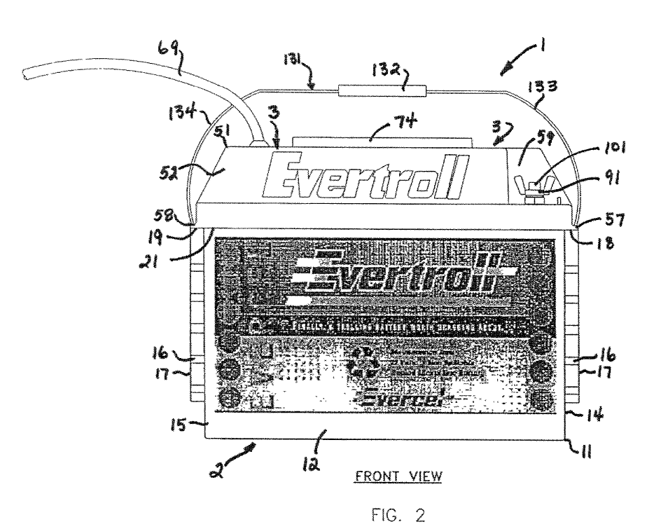

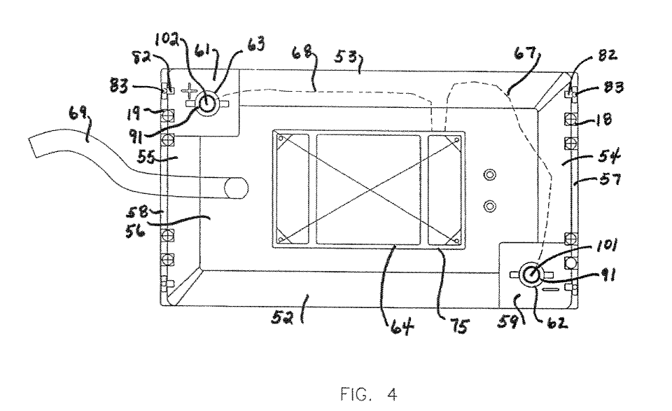

FIG. 1 shows an isometric view and FIGS. 2-5 show front, back, top and side views of a battery assembly 1 in accordance with the principles of the present invention. As shown, the battery assembly 1 comprises a rechargeable battery 2 and a separately formed battery charging unit 3. The battery 2 in the present embodiment is illustrated as a nickel zinc battery and the charging unit 3 has charging characteristics specifically adapted to charging a battery with nickel-zinc chemistry.

The rechargeable battery 2 has an outer casing 11 with flat front and back walls 12 and 13 and opposing right and left side walls 14 and 15. Protruding from each side wall 14 and 15 are intersecting horizontal and vertical ribs 16 and 17. Also, extending form the upper end of each of the side walls 14 and 15 are flange areas 18 and 19, respectively, and from the upper edge of the front an back walls flange areas 21 and 22, respectively.

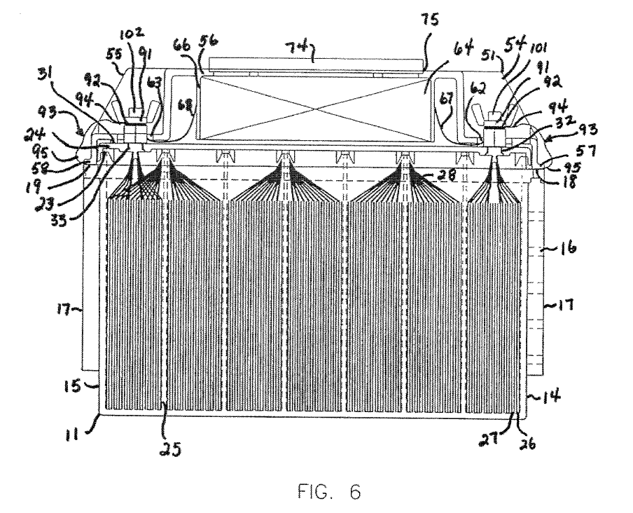

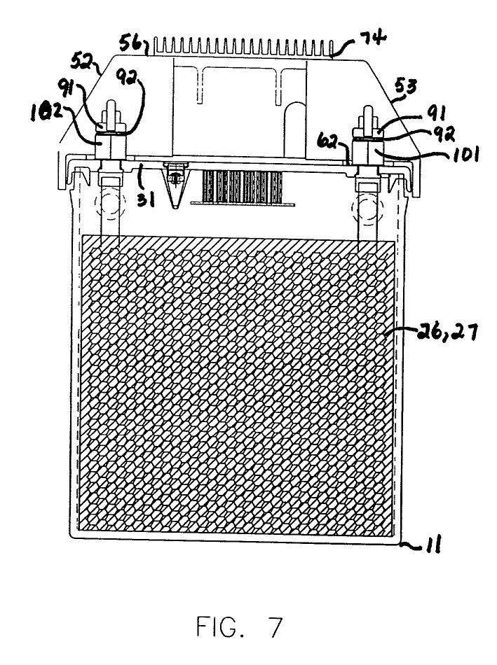

An upstanding ridge 23 (see FIG. 6) is situated inward of the flange areas 18, 19, 21 and 22 and extends around the entire periphery of the casing 11. A top member 24 seats over this ridge member to close the top of the casing.

Partitions 25 divide the casing into cell compartments each of which houses interleaved positive and negative battery electrodes 26 and 27. Tabs 28 in combination with through-the-wall connectors 29 (not visible) connect the electrodes in the cell compartments electrically in series and to negative and positive terminal posts 101 and 102 (see, FIG. 6). The terminal posts positive 101 and 102 are situated at diametrically opposite corners of the casing 11 and extend through apertures 32 and 33 in the upper surface 31 of the battery assembly 1. The latter surface 31 is formed by the upper surface of the top member 24, and the terminals 101 and 102 are the terminals to be used by a user to extract energy from the battery assembly.

In accordance with the principles of the present invention, the charging unit 3 is configured to allow the battery terminals 101 and 102 to be accessible for such energy extraction. In particular, the charging unit 3 comprises a cover 51 which is designed to cover the surface 31 of the battery 2 exclusive of the battery terminals 101 and 102.

As shown, the cover 51 comprises front and rear walls 52 and 53 and right and left side walls 54 and 55. Each of these walls has a lower vertical section and an upper inwardly tapered section. The tapered sections of the walls 52-55 terminate at a flat upper wall 56 of the cover. The cover 51 thus has a truncated pyramid shape.

The lower ends of the vertical sections of the front and rear walls 52 and 53 fit over the top member 24 and abut the flange areas 21 and 22 of the front and rear walls of the casing 11. The lower ends of the right and left side walls 54 and 55 also fit over the top member 24 of the casing 11 and are provided at their lower edges with respective flanges areas 57 and 58 which abut the flange areas 18 and 19 of the right and left side walls of the casing.

To allow for passage of the battery terminals 101 and 102, the tapered sections of the walls 52-55 are provided with recessed areas 59 and 61 overlying the diametrically opposed areas of the top surface 31 of the casing 11 having the apertures 32 and 33. The recessed areas in their lower walls abutting the surface 31 are likewise also provided with apertures 62 and 63, respectively, to permit passage of the battery terminals 101 and 102. Accessibility of the terminals to external connecting leads for extracting energy from the battery assembly 1 is thus assured, while the separately formed battery charging unit 3 is supported to overly the top surface of the battery 2.

The charger 64 of the charging unit 3 is supported in an upper chamber formed by a rectangular wall 66 extending downwardly from the inner surface 65 of the upper wall 56 of the cover 51. Leads 67 and 68 carry the direct current output of the charger 64 to the battery terminals 101 and 102. A further lead 69, passing through an aperture 71 in the upper wall 56, is connected to the charger and permits via a three prong connector 73 alternating current to be supplied from an external source to the charger. The charger 64 may be secured in place in the chamber by a suitable potting material and is of conventional design adapted to the battery chemistry of the battery 2, which in the present illustrative case is a nickel-zinc battery chemistry.

For cooling the charger 64, the charging unit 3 is further provided with a cooling member 74 which is secured to and supported above and the charger. The cooling member 74 also extends through a further aperture 75 in the upper wall 56 of the cover 51 to allow heat to escape from the member to outside air. The cooling member can be formed to have a plurality of longitudinal fins to promote cooling.

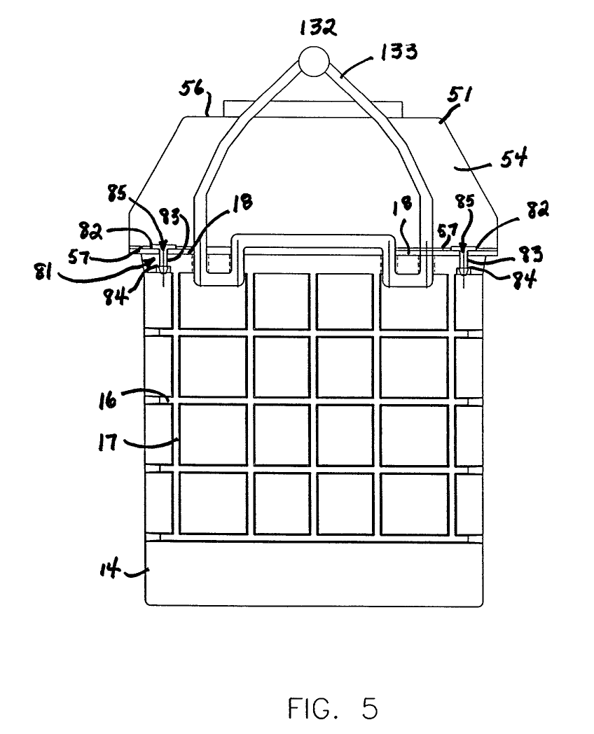

In further accordance with the invention, in order to connect the battery 2 and the separately formed charging unit 3 together in a such a way as to prevent separation and possible misplacement of the charging unit, an unlockable locking assembly 81 (see, FIG. 5) is used. More particularly, the units are locked together by a locking assembly in the form of a snap in lock which engages and holds the assembly together at the abutting flanges of the side walls of the casing 11 and the cover 51.

To this end, the flanges 57 and 58 of the side walls 54 and 55 are provided with through slots 82 at spaced positions along their length. In the present case, two through slots 82 at opposite ends of each flange are provided. The flanges 18 and 19 of the side walls 14 and 15 are, in turn, provided with apertures 83 which extend through the thickness of the flanges and which are aligned with through slots 82 in the flanges 57 and 58. The apertures 83 have a outward step at their lower ends to form an abutment 84.

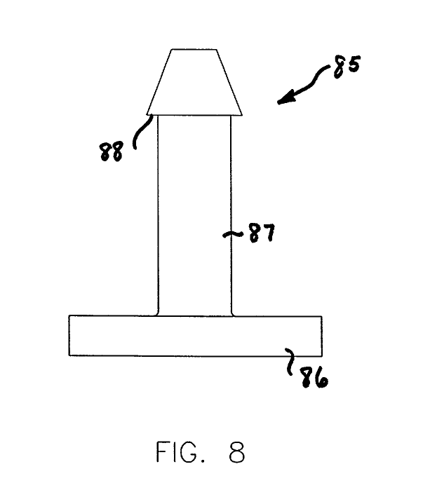

To lock the battery 2 and charger 3 together, a locking pin 85 is inserted through each pair of the aligned slot 82 and aperture 83. As shown in FIG. 8, each locking pin 85 has an enlarged head 86 followed by a cylindrical shaft 87 which terminates in a outward shoulder 88 which tapers inwardly to the terminal end of the pin. When inserted into an aligned slot 82 and aperture 83, the shoulder 87 of the pin is pushed past the step or abutment 84 of the aperture 83. Once past the abutment 84, the pin 85 snaps in place, with the head 86 of the pin 85 engaging the top surface of the slot 82 and the shoulder 87 of the pin engaging the abutment 84.

Insertion of the pins 85 thus locks the pins and the flanges in place, thereby locking the battery 2 and charger 3 together. Moreover, the pins 85 cannot be withdrawn unless they are tampered with and modified so that they no longer can provide the necessary locking function. Accordingly, they in cooperation with the slots 82 and apertures 83 provide the unlockable locking assembly 81. In order to further lock the charger and battery together, a glue can be placed around the entire peripheries of the mating flanges of the walls of the casing 11 and the cover 51.

In a further aspect of the invention, the battery assembly 1 is provided with terminal pieces 91 which facilitate use of the battery and connection of battery to external leads. More particularly, the terminal pieces are adapted both to engage the battery terminals and to remain connected to the battery assembly 1 when not engaged with the terminals.

In the present case, each terminal piece 91 is by a securing member in the form of a strap 93. A circumferential groove 92 in the piece 91 is seated in one end of the strap 94 so that the piece 91 is rotatable. The other end 95 of the strap 93 is held by the battery assembly 1 via the pin 85. When each terminal piece 91 is thus disengaged from its respective terminal of the battery 2, the piece remains securely held to the battery assembly via it associated strap 93.

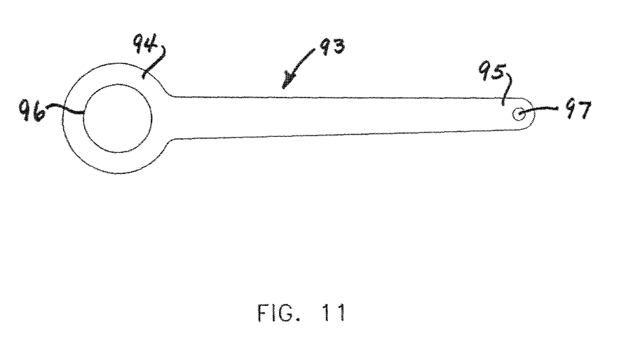

FIG. 11 shows the strap 93 in greater detail. The end 94 of the strap includes an enlarged aperture 96 and the end 95 includes a smaller aperture 97. In use, the terminal piece 91 is urged through the aperture 96 until the groove 92 reaches the aperture 96. At this position, the piece 91 becomes rotatably held through engagement of the areas of the strap adjacent the aperture 96 and the walls of the groove 92.

The smaller aperture 97 of the strap 93 is, in turn, adapted to be of sufficient diameter to pass the shoulder 88 and the shaft 87 of the pin 85. This permits the aperture 97 of the strap to be placed in alignment with a respective slot 82 and to allow passage of the pin 85 therethrough as the pin 85 is being inserted in the slot and the underlying aperture 83. Locking of the pin 85 in place thus also locks the strap end 95 to the battery assembly 1.

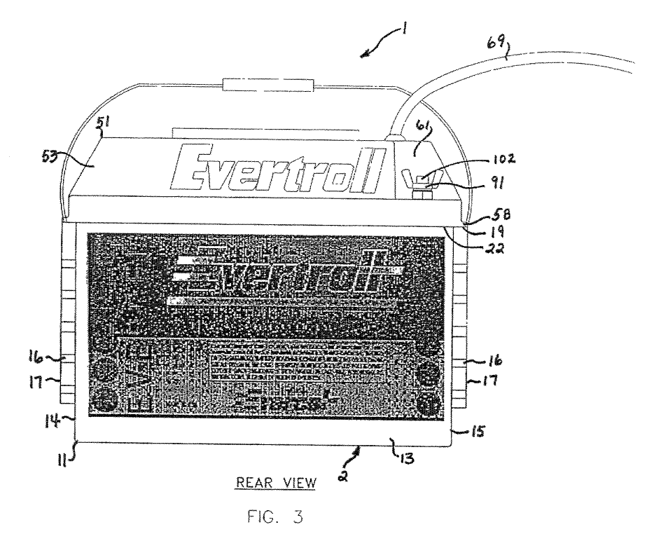

It is noted that the end 95 of each of the straps 93 can be locked to other areas of the battery assembly 1, instead of being locked by the pin 85 of the locking assembly 81. For example, posts 99 (see, FIGS. 2 and 3) can be provided in the respective recessed areas 59 and 61 of the cover 51 and the apertures 97 of the straps inserted over and locked to these posts and, hence, to the cover 51.

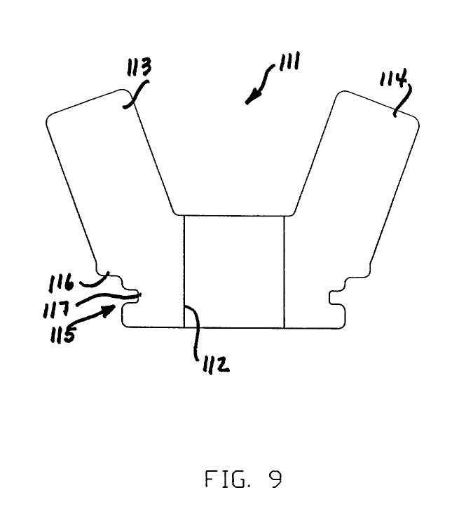

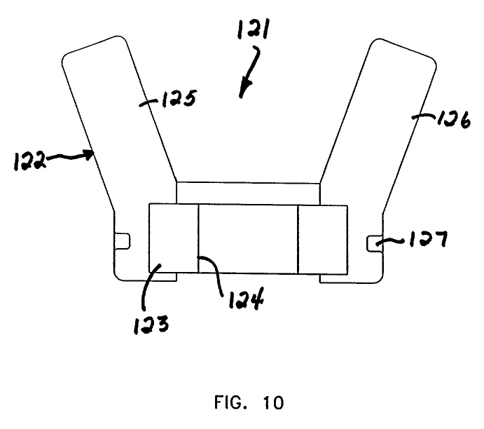

In an additional aspect of the invention, the terminal pieces 91 are designed to have a wing nut configuration which permits them to be easily attached to the respective positive or negative terminal. FIGS. 9 and 10 show two wing nut configurations for the pieces 91. In FIG. 9, the piece 111 is made of machined stainless steel with a threaded bore 112 and wings 113 and 114. The circumferential groove 115 has an upper inward step 116 followed by a lower inward step 117. In FIG. 10, the piece 121 includes an outer shroud 122 of molded plastic which surrounds a nut 123 having an interior threaded bore 124. The outer shroud 122 includes wings 125 and 126 and a circumferential groove 127.

The terminal pieces 91 can also be color coded to differentiate the piece to be used for the positive terminal of the battery assembly from the piece to be used for the negative terminal of the battery. Thus, the negative terminal piece can be colored black and the positive terminal piece red.

In the battery assembly 1, a handle assembly 131 is also provided This assembly comprises a handle 132 and attachment members 133 and 134. Each attachment member is passed through aligned slots and apertures in the flanges in the cover 51 and casing 11 to attach the attachment member to the battery assembly. This can be seen in FIG. 5 for the attachment member 133.

It should be noted that the various parts of the battery assembly 1 can be made of molded plastic. Thus, the casing 11, top member 31 and cover 51 of the assembly can all be formed from molded plastic parts.

In all cases it is understood that the above-described arrangements are merely illustrative of the many possible specific embodiments which represent applications of the present invention. Numerous and varied other arrangements can be readily devised in accordance with the principles of the present invention without departing from the spirit and scope of the invention.

What is claimed is:

1. A battery assembly comprising;
a rechargeable battery having an outer surface and positive and negative terminals extending from said outer surface;
a battery charging unit including: a cover for covering a portion of said outer surface of said battery exclusive of said positive and negative terminals; and a battery charger affixed to said cover for charging said rechargeable battery; and
a locking assembly for locking said cover of said battery charging unit to said rechargeable battery.

2. A battery assembly in accordance with claim 1, wherein:
said cover has a portion which is spaced from said portion of said outer surface of said rechargeable battery; and
said battery charger is attached to said portion of said cover so as to face said portion of said outer surface of said rechargeable battery.

3. A battery assembly in accordance with claim 2, wherein:
said battery charger includes an electrical lead which extends through an opening in said cover.

4. A battery assembly in accordance with claim 3, wherein
said electrical lead includes at an end a plug for plugging into an AC source.

5. A battery assembly in accordance with claim 4, wherein:
said battery charger includes further electrical leads adapted to be connected to the positive and negative terminals.

6. A battery assembly in accordance with claim 2, further comprising:
a cooling member in contact with said battery charger for cooling said battery charger.

7. A battery assembly in accordance with claim 6, wherein:
said portion of said cover includes an opening; and
said cooling member extends through said opening.

8. A battery assembly in accordance with claim 7, wherein
said cooling member is situated above said battery charger.

9. A battery assembly in accordance with claim 8, wherein
said cooling member has fins.

10. A battery assembly in accordance with claim 1, wherein:
said cover has first and second apertures through which said positive and negative terminals, respectively, extend.

11. A battery assembly in accordance with claim 10, wherein:
said cover has a peripheral region and a wall region extending outward from said peripheral region, said wall region having first and second recessed portions having first and second lower walls, respectively, which include said first and second apertures, respectively;
said peripheral region of said cover and said first and second lower walls of said recessed portions of said wall region being in contact with said portion of said surface of said rechargeable battery and said wall region other than said first and second lower walls of said recessed portions forming said portion of said cover.

12. A battery assembly in accordance with claim 11, wherein:
said wall region is shaped as a truncated pyramid.

13. A battery assembly in accordance with claim 11, wherein:
said positive and negative terminals extend from diametrically opposed positions of said portion of said outer surface of said battery;
and said recessed portions are at diametrically opposed positions of said wall region.

14. A battery assembly in accordance with claim 13, wherein
said portion of said outer surface of said battery is rectangular.

15. A battery assembly in accordance with claim 2, wherein:
said locking assembly is unlockable.

16. A battery assembly in accordance with claim 15, wherein:
said portion of said outer surface of said rechargeable battery has a flange area;
said cover has a flange area; and
said locking assembly locks said flange areas.

17. A battery assembly in accordance with claim 16, wherein
said flange area of said portion of said outer surface of said rechargeable battery has a one or more through apertures each having an abutment;
said flange area of said cover has a one or more through slots each aligned with a corresponding through aperture in the flange area of said portion of said outer surface of said rechargeable battery; and
said locking member includes one or more locking parts each locking part cooperating with an aligned set of a through slot in said flange area of said cover and a through aperture in the flange area of said portion of said surface of said rechargeable battery to lock said cover and said rechargeable battery together.

18. A battery assembly in accordance with claim 17, wherein:
each locking part includes a shaft having a head at a first end and a shoulder at a second end, whereby the second end of a said locking part can be urged through an aligned set of a through slot in said flange area of said cover and a through aperture in the flange area of said portion of said surface of said rechargeable battery until said shoulder passes through the aligned set of said through slot and through aperture, at which time the locking part becomes locked in place with the head engaging the top surface of the through slot and the shoulder engaging the abutment of the through aperture.

19. A battery assembly in accordance with claim 18, wherein:
said shaft of said locking part is tapered inward from said shoulder to the terminal point of the second end to permit urging of said locking part through said aligned set of through slot and through aperture.

20. A battery assembly in accordance with claim 2, further comprising:
first and second terminal pieces for engaging said positive and negative terminals, respectively, to secure first and second external leads to said positive and negative terminals, respectively; and
a securing member for each of said first and second terminal pieces to secure the respective terminal piece to the battery assembly when the terminal piece is disengaged from the respective positive or negative terminal.

21. A battery assembly in accordance with claim 20, wherein:
each terminal piece includes a circumferential groove;
each securing member includes a strap having first and second ends, said first end being adapted to be connected to said battery assembly and said second end having an aperture through which the corresponding terminal piece is inserted until the groove of the terminal piece is received in the aperture, whereby the terminal piece is held by the strap.

22. A battery assembly accordance with claim 21, wherein:
each terminal piece is held in by the respective strap so as to be rotational relative to the strap.

23. A battery assembly in accordance with claim 22, wherein:
each terminal piece comprises a wing nut and said circumferential groove of the terminal piece extends about the outer circumference of the wing nut.

24. A battery assembly in accordance with claim 23 wherein:
said second end of each strap is received in a part of the battery assembly to secure the terminal piece to the battery assembly.

25. A battery assembly in accordance with claim 24, wherein:
said part of said battery assembly includes said locking member.

26. A battery assembly in accordance with claim 23, wherein:
the wing nut for said positive terminal is of a first color and the and the wing nut for said negative terminal is a second color.

27. A battery assembly in accordance with claim 23, wherein:
each wing nut is a molded plastic wing shaped piece surrounding a nut.

28. A battery assembly in accordance with claim 27, wherein:
the groove in said wing nut has a inward step.

29. A battery assembly in accordance with claim 23, wherein:
each wing nut is a stainless steel piece.

30. A battery assembly in accordance with claim 29, wherein:
the groove in said wing nut has multiple inward steps.

31. A battery assembly in accordance with claim 20, wherein:
said rechargeable batter is a nickel-zinc battery.

32. A battery assembly in accordance with claim 2, wherein:
said rechargeable battery is a nickel-zinc battery.

33. A battery assembly in accordance with claim 1, wherein:
said rechargeable battery is a nickel-zinc battery.

34. A battery assembly comprising;
a rechargeable battery having an outer surface and positive and negative terminals extending from said outer surface;
a battery charging unit including: a cover for covering a portion of said outer surface of said battery; and a battery charger affixed to said cover for charging said rechargeable battery; and
an unlockable locking assembly for locking said cover of said battery charging unit to said rechargeable battery.

35. A battery assembly in accordance with claim 34, wherein:
said rechargeable battery is a nickel-zinc battery.

36. A battery assembly in accordance with claim 34, wherein:
said portion of said outer surface of said rechargeable battery has a flange area;
said cover has a flange area; and
said locking assembly locks said flange areas.

37. A battery assembly in accordance with claim 36, wherein
said flange area of said portion of said outer surface of said rechargeable battery has a one or more through apertures each having an abutment;
said flange area of said cover has a one or more through slots each aligned with a corresponding through aperture in the flange area of said portion of said outer surface of said rechargeable battery; and
said locking member includes one or more locking parts each locking part cooperating with an aligned set of a through slot in said flange area of said cover and a through aperture in the flange area of said portion of said surface of said rechargeable battery to lock said cover and said rechargeable battery together.

38. A battery assembly in accordance with claim 37, wherein:
each locking part includes a shaft having a head at a first end and a shoulder at a second end, whereby the second end of a said locking part can be urged through an aligned set of a through slot in said flange area of said cover and a through aperture in the flange area of said portion of said surface of said rechargeable battery until said shoulder passes through the aligned set of said through slot and through aperture, at which time the locking part becomes locked in place with the head engaging the top surface of the through slot and the shoulder engaging the abutment of the through aperture.

39. A battery assembly in accordance with claim 38, wherein:
said shaft of said locking part is tapered inward from said shoulder portion to the terminal point of the second end to permit urging of said locking part through said aligned set of through slot and through aperture.

40. A battery assembly comprising;
an rechargeable battery having an outer surface and positive and negative terminals extending from said outer surface; and
first and second terminal pieces for engaging said positive and negative terminals, respectively, to secure first and second external leads to said positive and negative terminals, respectively; and
a securing member for each of said first and second terminal pieces to secure the respective terminal piece to the battery assembly when the terminal piece is disengaged from the respective positive or negative terminal.

41. A battery assembly in accordance with claim 40, wherein:
said rechargeable battery is a nickel-zinc battery.

42. A battery assembly in accordance with claim 40, further comprising:
a battery charging unit including: a cover for covering a portion of said outer surface of said battery exclusive of said positive and negative terminals; and a battery charger affixed to said cover for charging said rechargeable battery; and
a locking assembly for locking said cover of said battery charging unit to said rechargeable battery.

43. A battery assembly in accordance with claim 42, wherein:
said locking assembly is unlockable.

44. A battery assembly in accordance with claim 40, wherein:
each terminal piece includes a circumferential groove;
each securing member includes a strap having first and second ends, said first end being adapted to be connected to said battery assembly and said second end having an aperture through which the corresponding terminal piece is inserted until the groove of the terminal piece is received in the aperture, whereby the terminal piece is held by the strap.

45. A battery assembly accordance with claim 44, wherein:
each terminal piece is held by the respective strap so as to be rotational relative to the strap.

46. A battery assembly in accordance with claim 45, wherein:
each terminal piece comprises a wing nut and said circumferential groove of the terminal piece extends about the outer circumference of the wing nut.

47. A battery assembly in accordance with claim 46 wherein:
said second end of each strap is received in a part of the battery assembly to secure the terminal piece to the battery assembly.

48. A battery assembly in accordance with claim 47, wherein:
said part of said battery assembly includes said locking member.

49. A battery assembly in accordance with claim 46, wherein:
the wing nut for said positive terminal is of a first color and the and the wing nut for said negative terminal is a second color.

50. A battery assembly in accordance with claim 46, wherein:
each wing nut includes a molded plastic wing shaped piece surrounding a nut.

51. A battery assembly in accordance with claim 50, wherein:
the groove in said wing nut has a inward step.

52. A battery assembly in accordance with claim 46, wherein:
each wing nut is a stainless steel piece.

53. A battery assembly in accordance with claim 52, wherein:
the groove in said wing nut has multiple inward steps.
